(19) United States
(12) Patent Application Publication
(10) Pub. No.: US 2008/0039992 A1
(43) Pub. Date: Feb. 14, 2008

(54) Sensor Arrangement

(76) Inventors: Peter Lohberg, Friedrichsdorf (DE); Alexander Kolbe, Gross-Zimmern (DE); Bernhard Hartmann, Friedberg (DE)

Correspondence Address: RATNERPRESTIA, P O BOX 980, VALLEY FORGE, PA, 19482-0980, US

(21) Appl. No.: 10/592,620

(22) PCT Filed: Mar. 16, 2005
(86) PCT No.: PCT/EP05/51213

§ 371 Date: Jun. 6, 2007

(30) Foreign Application Priority Data
Mar. 16, 2004 (DE) 10 2004 012 686.0
Mar. 16, 2004 (DE) 10 2004 012 688.7

(51) Int. Cl. G01M 17/007; G06F 17/00

(52) U.S. Cl. 701/29

(57) ABSTRACT

A sensor arrangement for detecting movements, which is designed as a monolithic arrangement and in which several sensors are integrated. A first sensor is provided to detect a linear acceleration and a second sensor to detect a yaw rate. The sensor arrangement also comprises a third sensor for detecting yaw acceleration.

This application is the U.S. national phase application of PCT International Application No. PCT/EP2005/051213, filed Mar. 16, 2005, which claims priority to German Patent Application No. DE 10 2004 012 686.0, filed Mar. 16, 2004 and German Patent Application No. DE 10 2004 012 688.7, filed Mar. 16, 2004.

### BACKGROUND OF THE INVENTION

1. Technical Field

The present invention relates to a sensor arrangement for detecting movements, which is designed as a monolithic arrangement.

2. Description of the Related Art

In driving stability control operations (ESP) for controlling and limiting undesirable yaw movements of the vehicle about its vertical axis, sensors are used to measure essential variables, which can be varied by the driver on purpose. The variables that can be changed by the driver relate to the steering angle, the accelerator pedal position, the brake pressure, the lateral acceleration of the vehicle as well as the rotating speed of the individual vehicle wheels. A nominal yaw rate is calculated from the measured variables. Additionally, a yaw rate sensor is used to measure the actual value of the yaw rate, which develops in response to the driving maneuver. If the actual value of the yaw rate differs from the calculated nominal value of the yaw rate by a predetermined degree jeopardizing driving stability, the yaw motion of the vehicle and, thus, the actual yaw rate is limited to admissible values by way of a targeted brake and engine intervention.

In addition to driving stability control systems, passenger protection devices serve to increase the safety of passengers in a motor vehicle. Only one single motor vehicle is involved in a considerable number of accidents. Deadly injuries occur in accidents of this type mostly in case the motor vehicle overturns about its longitudinal axis in the accident. Vehicle rollover can have fatal consequences especially in convertibles. For this reason, passenger protection devices are known for convertibles, which safeguard a survival space for the vehicle occupants in order that they will not get into direct contact with the ground when rollover takes place. A safety roll bar extending over the heads of the vehicle passengers is used for this purpose. However, a stationary safety roll bar will greatly impair the aesthetic impression of convertibles. This is why some convertibles are equipped with protecting devices which, in the normal case, are hidden in the vehicle seats or behind the vehicle seats and will only pop up in case of an imminent rollover to fulfill their protective function then. The initiation of a protection device of this type in good time requires the detection of an imminent rollover in good time.

DE 101 23 215 A1 discloses a method for activation of a passenger protection device in a motor vehicle, which among others is mainly based on measuring the yaw acceleration of the motor vehicle about the vehicle's longitudinal axis.

In addition, DE 199 62 685 C2 discloses a method and a system for determining the angular acceleration of a motor vehicle turning about its longitudinal axis. The prior art method calculates the angular acceleration from the difference of the detected accelerations and the component of a distance vector being normal to the axis of rotation.

DE 199 22 154 C2 discloses a device for generating electric signals, which reflect the yaw rate, the acceleration, and the roll velocity of the vehicle body.

Basic components of these prior art methods and devices are sensor arrangements, which detect linear velocities and accelerations as well as yaw rates and yaw accelerations about different axes of an initial system attached to a vehicle. To limit costs of manufacture, sensor arrangements of this type are made of silicon as micromechanical systems. The monolithic design of acceleration sensors for two or three directions in space is known in prior art. Sensors of this type are commercially available e.g. with the makers VTI and Kionix.

In addition, a monolithic arrangement is described in U.S. Pat. No. 5,313,835, which is composed of a two-axis gyroscope, a uniaxial gyroscope, a three-axis linear acceleration sensor, and a microprocessor electronic unit. The two-axis gyroscope and the uniaxial gyroscope add to become a gyroscope measuring in three directions in space. The prior-art sensor arrangement is appropriate to measure yaw rates and linear accelerations in three directions in space.

### SUMMARY OF THE INVENTION

Based on the above, an object of the invention involves disclosing a sensor arrangement, which exhibits improved characteristics compared to the state of the art.

This object is achieved by a sensor arrangement as described herein. The sensor arrangement of the invention that is intended to detect movements is configured as a monolithic arrangement in which several sensors are integrated. A first sensor is provided for detecting a linear acceleration and a second sensor for detecting a yaw rate. According to the invention, the sensor arrangement is characterized in that it comprises a third sensor for detecting yaw acceleration.

Advantageously, the sensor arrangement can be configured on a monocrystal substrate. In one embodiment of the invention, the monocrystal substrate is made of silicon. It is favorable in this respect that the silicon technology is matured so that high-quality sensors can be manufactured at low costs.

In a preferred embodiment, the sensors are designed as micromechanical structures in the substrate.

According to another design, it is favorably provided that all or individual sensors and evaluating circuits are connected to and contacted by the substrate by means of flip-chip technology or cementing, soldering and wire-bonding.

In an application in the automotive industry, it has proven especially expedient when the sensors on the substrate are aligned in such a fashion that they are appropriate in a corresponding installation position in a motor vehicle, to measure the linear acceleration in the longitudinal direction of the motor vehicle, the yaw rate, and the roll acceleration about the longitudinal axis of the motor vehicle. The yaw rate represents an important input quantity for driving dynamics control operations, while the roll acceleration frequently controls the initiation of passenger protection systems, which have been described hereinabove.

In an optional improvement of the invention, the sensor arrangement includes a fourth sensor, which is suitable for detecting a linear acceleration and is aligned on the substrate in such a way as to be able to additionally measure a linear acceleration across the longitudinal axis of the vehicle. The lateral acceleration is another useful input quantity for driving dynamics control operations.

In another embodiment of the sensor arrangement of the invention, the direction of measurement of the sensors can lie in the principal plane defined by the substrate, while in another embodiment the direction of measurement of the sensors can be disposed perpendicular to the principal plane defined by the substrate.

It has proven favorable in cases of practical application when several sensor arrangements are integrated to form a subassembly, when the subassembly comprises two sensor arrangements in which the directions of measurement of the sensors lie in the principal plane defined by the substrate, and the directions of measurement of the two sensor arrangements are oriented perpendicular to each other, and when the subassembly comprises an additional sensor arrangement in which the direction of measurement of the sensors lie normal to the principal plane defined by the substrate.

### BRIEF DESCRIPTION OF THE DRAWINGS

Embodiments of the invention are represented in the drawings. In the accompanying drawings:

FIGS. 1a and 1b show a view of the symbolism of parameters used and the directions of reference;

FIGS. 2a to 2b are schematic views of the components of the sensor arrangement of the invention, and

FIGS. 3a to 3c are schematic views of the integration of the sensor arrangement into a packing.

### DETAILED DESCRIPTION OF THE PREFERRED EMBODIMENTS

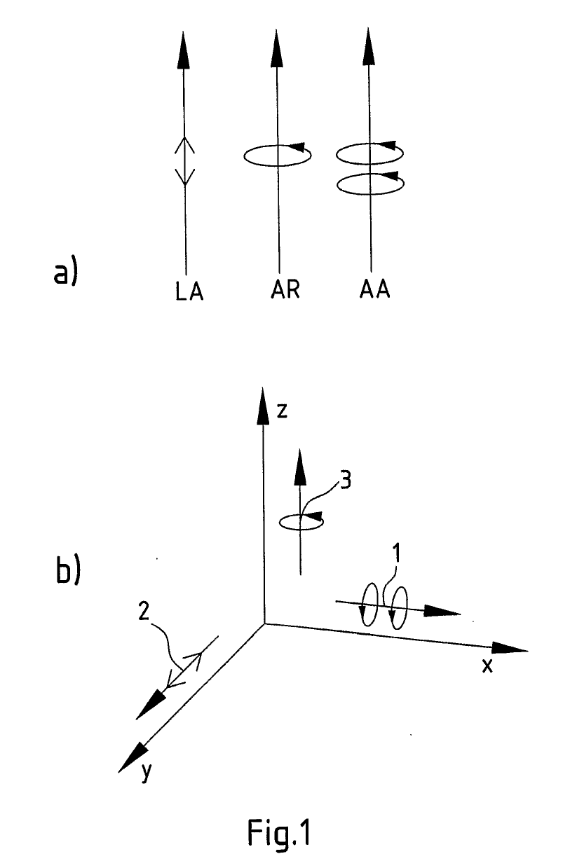

FIG. 1a illustrates the symbols for sensors integrated in the sensor arrangement, which are used to explain the invention. Each sensor is shown as an arrow in combination with a parameter identification code. The arrow indicates the direction of measurement of the respective sensor. The arrow abstracts the presence of an associated transducer, which is realized e.g. in silicon by means of etching technology. Etching technologies of this type for different systems are known in the prior art. In particular, a linear acceleration sensor LA is represented. A positive sign implies in this case acceleration in the direction of the arrow. A yaw rate sensor AT is represented by a circle about an arrow, and the direction of rotation is clockwise in the direction of the arrow. This corresponds to the so-called ‘right-hand rule’, according to which the fingers of the right hand indicate the direction of rotation when the thumb is pointing in the direction of arrow. A yaw acceleration sensor AA is represented by two circles about an arrow, and the yaw acceleration is clockwise about the direction of the arrow.

FIG. 1b illustrates the directional characteristics explained with respect to FIG. 1a for better explanation with reference to a system of coordinates. With reference to the XY-plane, the arrow 1 symbolizes a yaw acceleration sensor being responsive to the X-direction. The arrow 2 refers to a linear acceleration sensor being responsive to the Y-direction. Finally, arrow 3 designates a yaw rate sensor being responsive to the Z-direction. Assuming that the silicon substrate as a chip is placed in the XY-plane, the directions of measurement of the transducers for yaw acceleration AR 1 and linear acceleration AA2 are ‘in plane’ and the transducer for the yaw rate AA3 is ‘out of plane’ according to the technically customary designation.

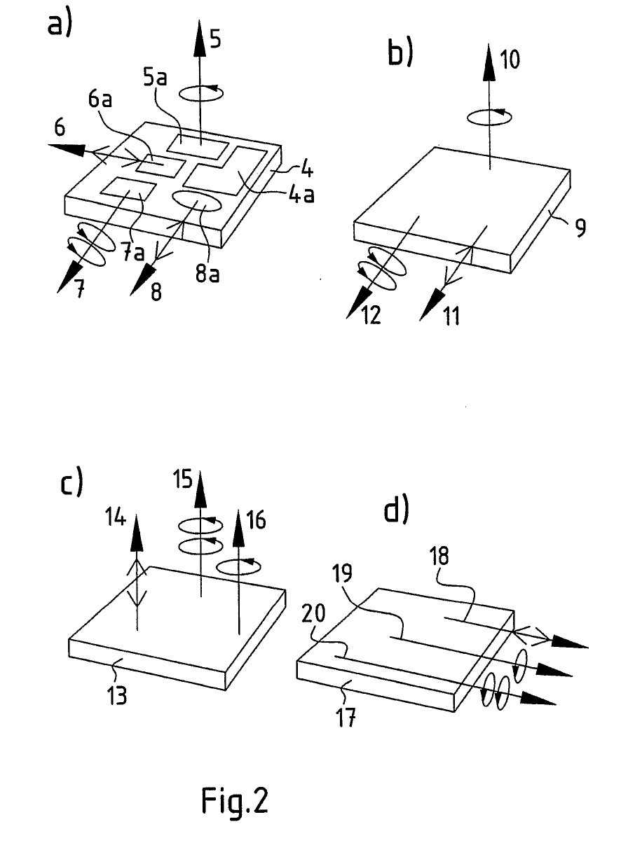

FIGS. 2a to 2d represent the components of the sensor arrangement. The represented structures relate to embodiments based on micromechanical systems being made on the basis of silicon. Techniques of this type are known to one skilled in the art and can be adapted so as to conform to the respectively prevailing case of application of the invention.

FIG. 2a shows a silicon chip 4 with an integrated structure of yaw rate sensor 5, linear acceleration sensor 6, yaw acceleration sensor 7, and linear acceleration sensor 8. Surfaces 5a, 6a, 7a, 8a symbolize associated transducer chip surfaces. A surface 4a symbolizes a co-integrated electronic circuit for operation or pre-stage operation of the transducers 5, 6, 7. In a favorable case of application, this component is employed as a cased inertial analyzer for an ESP application combined with a rollover protection. For this purpose, the chip plane is aligned in parallel to the vehicle plane or the earth's surface. The direction of measurement of the sensors 7, 8 is identical with the driving direction of a vehicle into which the sensor arrangement is mounted. The inertial analyzer detects—in relation to the vehicle—the yaw rate, the roll acceleration, the longitudinal acceleration, and the lateral acceleration. This embodiment represents a favorable combination of known sensors with a yaw acceleration sensor 7.

FIG. 2b shows a diagrammatic view of a frequently required, reduced embodiment of the inertial analyzer of FIG. 2a. The analyzer comprises a chip 9, a yaw rate sensor 10, a linear acceleration sensor 11, and a yaw acceleration sensor 12. The direction of measurements of the sensors 10, 11, 12 are oriented exactly as the directions of measurement of the corresponding sensors 5, 7, 8 of the inertial analyzer described in FIG. 2a.

FIG. 2c shows a component with a chip 13, a linear accelerator sensor 14, a yaw acceleration sensor 15, and a yaw rate sensor 16. The directions of measurement of all three sensors 14, 15, 16 are realized corresponding to the definition ‘out of plane’, which has been described hereinabove.

FIG. 2d shows a component with a chip 17, which comprises a linear accelerator sensor 18, a yaw rate sensor 19, and a yaw acceleration sensor 20. The directions of measurement of all three sensors are realized corresponding to the definition ‘in plane’, which has been described hereinabove.

In a possible embodiment of the invention, it is arranged that a chip 13 and two chips 17 are combined with each other in such a manner that an inertial analyzer develops which measures in all three directions in space the yaw rate, the linear acceleration, and the yaw acceleration in addition. The three chips are aligned ‘in plane’ for this purpose. In this arrangement, the two chips 17 rotate at a right angle relative to each other in plane so that their sensorial directions of measurement are aligned normal to each other and orthogonal to the directions of measurement of the sensors on the chip 13.

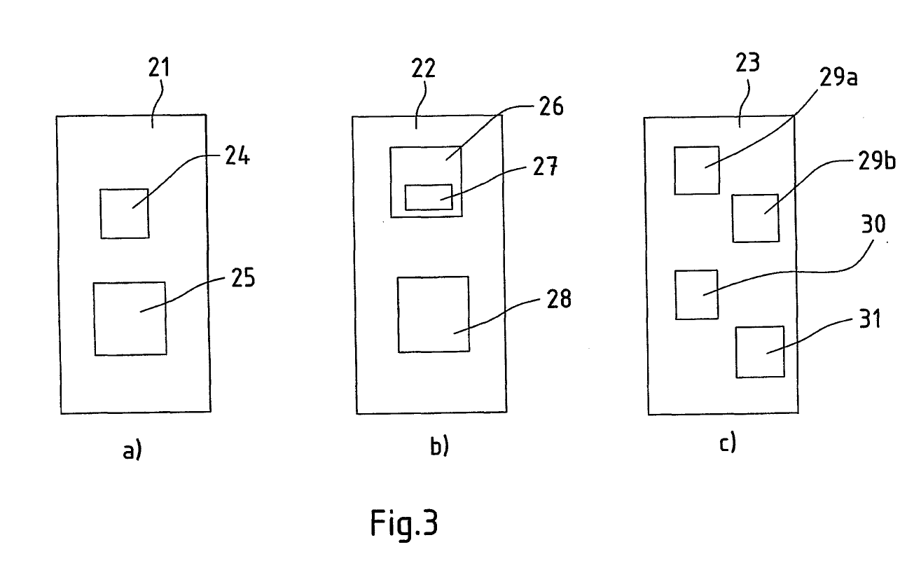

FIG. 3 shows schematically in several embodiments the integration of several monolithic sensor arrangements of the invention in one single packaging casing.

In FIG. 3a, a casing 21 encloses a sensorial component 24 of the type described in connection with FIG. 2a or FIG. 2b, as well as an associated separate electronic circuit 25, which evaluates the sensor output signals.

In FIG. 3b, a casing 22 encloses a sensor component 26 of the type described in connection with FIG. 2a or FIG. 2b, as well as an associated separate electronic circuit 28, which evaluates the sensors of the component 26. The sensor component 26 comprises a co-integrated electronic circuit 27.

In FIG. 3c, a casing 23 encloses two sensor components 29a, 29b according to FIG. 2d, a component 30 according to FIG. 2c, as well as an associated separate electronic circuit 31. The sensorial components 29a, 29b, 30 can contain additional co-integrated electronic circuits. This arrangement is a defined embodiment of an inertial analyzer, which measures the yaw rate, the linear acceleration, and the yaw acceleration in all three directions of space.

1-10. (canceled)

11. A sensor arrangement for detecting movements comprising: a first sensor for detecting a linear acceleration; a second sensor for detecting a yaw rate; and a third sensor for detecting a yaw acceleration, wherein the first, second and third sensors are integrated in a monolithic arrangement.

12. The sensor arrangement according to claim 11, wherein the sensor arrangement is configured on a monocrystal substrate.

13. The sensor arrangement according to claim 12, wherein the monocrystal substrate is made of silicon.

14. The sensor arrangement according to claim 12, wherein the sensors are designed as micromechanical structures in the substrate.

15. The sensor arrangement according to claim 12, wherein at least one of the sensors is connected to and contacted by the substrate by means of flip-chip technology or cementing, soldering and wire-bonding.

16. The sensor arrangement according to claim 12, further comprising at least one evaluating circuit wherein at least one of the sensors or the evaluating circuit is connected to and contacted by the substrate by means of flip-chip technology or cementing, soldering and wire-bonding.

17. The sensor arrangement according to claim 12, wherein the sensors are aligned on the substrate such that, in a corresponding installation position in a motor vehicle, the sensors respectively measure the linear acceleration in the longitudinal direction of the motor vehicle, the yaw rate and the roll acceleration about the longitudinal axis of the motor vehicle.

18. The sensor arrangement according to claim 17, wherein the sensor arrangement includes a fourth sensor for detecting a linear acceleration which is aligned on the substrate to additionally measure a linear acceleration normal to the longitudinal axis of the vehicle.

19. The sensor arrangement according to claim 12, wherein the direction of measurement of the sensors lies in a principal plane defined by the substrate.

20. The sensor arrangement according to claim 12, wherein the direction of measurement of the sensors is disposed perpendicular to a principal plane defined by the substrate (13).

21. The sensor arrangement according to claim 12, wherein several sensor arrangements are integrated to form a subassembly, the subassembly comprising two sensor arrangements in which the directions of measurement of the sensors lie in a principal plane defined by the substrate, and the directions of measurement of the two sensor arrangements are oriented perpendicular to each other, and in that the subassembly comprises an additional sensor arrangement in which the direction of measurement of the sensors is normal to the principal plane defined by the substrate.
